(19) United States
(12) Patent Application Publication
(10) Pub. No.: US 2005/0170954 A1
(43) Pub. Date: Aug. 4, 2005

(54) Exhaust gas cleaning catalyst

(75) Inventors: Kohei Yoshida, Susono-shi (JP); Shinya Hirota, Susono-shi (JP); Yasuaki Nakano, Sunto-gun (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 11/036,362

(22) Filed: Jan. 18, 2005

(30) Foreign Application Priority Data
Feb. 2, 2004 (JP) 2004-025201

(51) Int. Cl. B01J 23/40

(52) U.S. Cl. 502/325

(57) ABSTRACT

An exhaust gas cleaning catalyst is formed of a carrier layer, and a noble metal catalyst and a SOₓ absorbing agent both carried on the carrier layer. The carrier layer of the exhaust gas cleaning catalyst includes at least a first distribution portion and a second distribution portion each having a different sulfate retention level. The sulfate retention level of the first distribution portion is lower than the sulfate retention level of the second distribution portion, and the noble metal catalyst is carried on the first distribution portion such that a SOₓ that has been oxidized on the noble metal catalyst diffuses toward the second distribution portion so as to be settled therein.

### INCORPORATION BY REFERENCE

The disclosure of Japanese Patent Application No.2004-25201 filed on Feb. 2, 2004, including the specification, drawings and abstract are incorporated herein by reference in its entirety.

### BACKGROUND OF THE INVENTION

1. Field of Invention

The invention relates to an exhaust gas cleaning catalyst that absorbs SOₓ contained in exhaust gas, and to prevent the absorbed SOₓ from flowing into a NOₓ absorbing/reducing type catalyst for the purpose of avoiding so called sulfur poisoning.

2. Description of Related Art

The use of a three-way catalyst for cleaning exhaust gas by oxidizing CO and HC, and reducing NOₓ contained in the exhaust gas simultaneously has been well known as the exhaust gas cleaning catalyst for an automobile. For example, the three-way catalyst has a carrier layer formed of y-alumina on a carrier base material such as cordierite, on which a noble metal catalyst such as platinum (Pt), palladium (Pd), and rhodium (Rd) is carried.

In view of the global environmental protection, reduction in carbon dioxide (CO₂) in the exhaust gas discharged from the internal combustion engine of the vehicle has been increasingly focused. In response to the aforementioned concern, the system for burning the fuel in atmosphere in excess of oxygen, in other words, lean-burn combustion system has been proposed. In the lean-burn combustion state, quantity of the fuel used for improving the fuel efficiency is reduced so as to restrain generation of CO₂ as the burned exhaust gas.

The generally employed three-way catalyst performs both oxidization of CO and HC, and reduction of NOₓ contained in the exhaust gas simultaneously at a stoichiometric air/fuel (A/F) ratio. In the atmosphere of the exhaust gas in excess of oxygen in the lean-burn combustion state, the oxidizing reaction for purifying CO and HC is actively performed. On the contrary, in the aforementioned state, the reducing reaction for purifying NOₓ is not actively performed, resulting in insufficient purification of NOₓ.

There has been a system in which the lean-bum combustion in excess of oxygen is normally performed, and the combustion at the A/F ratio ranging from stoichiometric to rich state is temporarily performed so as to bring the exhaust gas into the reducing atmosphere for purifying NOₓ. In the aforementioned system, the exhaust gas cleaning catalyst of NOₓ absorbing/reducing type has been proposed, in which NOₓ is absorbed in the lean-burn combustion state, and the absorbed NOₓ is released in the atmosphere at the A/F ratio ranging from stoichiometric to rich state. The aforementioned catalyst allows absorption of NOₓ by a NOₓ absorbing material in the system where the A/F ratio is controlled from the lean state to the stoichiometric to rich state in a pulse-like manner, and further allows release of the absorbed NOₓ at the A/F ratio from the stoichiometric to rich state such that the released NOₓ reacts with the reducing component such as HC and CO to be removed. Accordingly the NOₓ contained in the exhaust gas discharged from the lean burn engine may be efficiently purified.

The fuel contains a small amount of sulfur which is oxidized during combustion of the fuel or by the catalyst, thus generating SOₓ. The SOₓ that is acidic may be reacted with the NOₓ absorbing material that is basic, and accordingly forming a sulfate. As a result, the NOₓ absorbing capability of the NOₓ absorbing material is gradually deteriorated. The aforementioned phenomenon is well known as the sulfur poisoning (S-poisoning) of the NOₓ absorbing material.

For the purpose of coping with the S-poisoning, there has been an exhaust emission control device having a SOₓ absorbing agent disposed in an exhaust gas passage of the internal combustion engine upstream side of the NOₓ absorbing material. In this device, when the mixture in the lean state is combusted, the SOₓ absorbing agent absorbs SOₓ, and the absorbed SOₓ is released when the A/F ratio of the mixture is selected from the lean state to the rich state as disclosed in JP-A-6-173652, for example.

Another publication of JP-A-2001-70790 discloses the exhaust gas cleaning catalyst of NOₓ absorbing/reducing type that includes the catalyst carrier layer of double layer type having an upper layer and a lower layer. In the aforementioned system, the Pt concentration of the upper layer is higher than that of the lower layer such that the SOₓ on the upper layer is trapped so as to prevent its diffusion into the lower layer.

In the aforementioned exhaust gas cleaning catalyst, as the trapped amount of SOₓ is increased, it becomes difficult to trap SOₓ sufficiently, thus reducing SOₓ trap ratio. Especially when the exhaust gas temperature is low, the SOₓ trap ratio becomes considerably lowered. In the aforementioned generally employed exhaust gas cleaning catalyst, the SOₓ that has been trapped in the lean atmosphere is released in the stoichiometric to rich atmosphere so as to allow release of the SOₓ.

Recently the sulfur content of the fuel has been considerably reduced. Accordingly, the SOₓ absorbing agent exhibits sufficient SOₓ absorbing capability without recovery or releasing the SOₓ.

The aforementioned catalyst is designed to trap the SOₓ at a point close to the surface of the catalyst carrier layer. In this case, the whole catalyst carrier layer cannot be used for trapping the SOₓ sufficiently unless the recovery process or release of the SOₓ is performed.

### SUMMARY OF THE INVENTION

It is an object of the invention to provide an exhaust gas cleaning catalyst that is capable of trapping SOₓ sufficiently using the whole catalyst carrier layer without the recovery process or release of the SOₓ.

According to a first aspect of the invention, an exhaust gas cleaning catalyst is formed of a carrier layer, and a noble metal catalyst and a SOₓ absorbing agent both carried on the carrier layer. The carrier layer of the exhaust gas cleaning catalyst includes at least a first distribution portion and a second distribution portion each having a different sulfate retention level. The sulfate retention level of the first distribution portion is lower than the sulfate retention level of the second distribution portion, and the noble metal catalyst is carried on the first distribution portion such that a SOₓ that has been oxidized on the noble metal catalyst diffuses toward the second distribution portion so as to be settled therein.

According to a second aspect of the invention, an exhaust gas cleaning catalyst is formed of a carrier layer, and a noble metal catalyst and a SOₓ absorbing agent both carried on the carrier layer. The carrier layer of the exhaust gas cleaning catalyst includes at least a first distribution portion and a second distribution portion each having a different basic level. The basic level of the first distribution portion is lower than the basic level of the second distribution portion, and the noble metal catalyst is carried on the first distribution portion such that a SOₓ that has been oxidized on the noble metal catalyst diffuses toward the second distribution portion so as to be settled therein.

According to a third aspect of the invention, an exhaust gas cleaning catalyst is formed of a carrier layer, and a noble metal catalyst and a SOₓ absorbing agent both carried on the carrier layer. The carrier layer of the exhaust gas cleaning catalyst includes at least a first distribution portion and a second distribution portion each having a different sulfate decomposition temperature. The sulfate decomposition temperature of the first distribution portion is lower than the sulfate decomposition temperature of the second distribution portion, and the noble metal catalyst is carried on the first distribution portion such that a SOₓ that has been oxidized on the noble metal catalyst diffuses toward the second distribution portion so as to be settled therein.

The exhaust gas cleaning catalyst according to the invention allows the trapped SOₓ to be diffused and settled in the area where the sulfate retention is relatively higher. This makes it possible to allow the whole catalyst carrier layer to be used for trapping the SOₓ. Especially the sulfate retention in the lower layer of the carrier layer is made higher than that in the upper layer of the carrier layer such that the SOₓ absorbed on the surface of the upper layer is diffused toward the lower layer exhibiting higher sulfate retention. Accordingly, the SOₓ may be oxidized and trapped further efficiently.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a view showing a mechanism of SOₓ absorption;

FIG. 2 is a graph showing each SOₓ trap ratio of Ba and Li, respectively;

FIG. 3 is a graph showing each time taken for releasing SOₓ from Ba and Li, respectively upon temperature increase to 600° C.;

FIG. 4 is a view showing an exhaust gas cleaning catalyst in one embodiment of the invention; and

FIG. 5 is a view showing an exhaust gas cleaning catalyst in another embodiment of the invention.

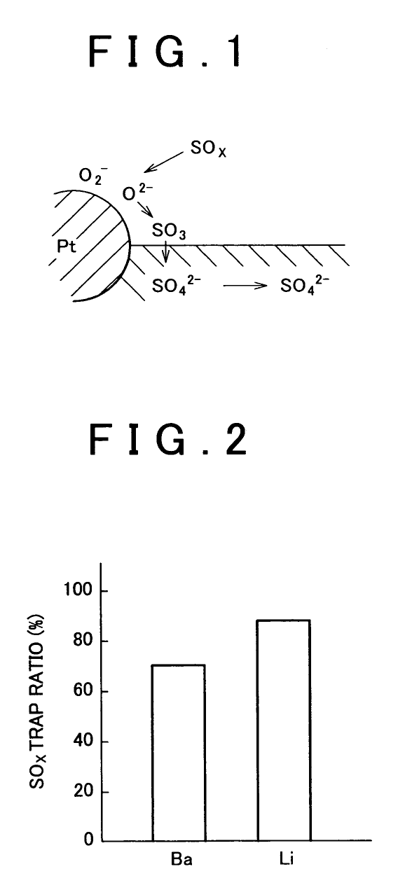

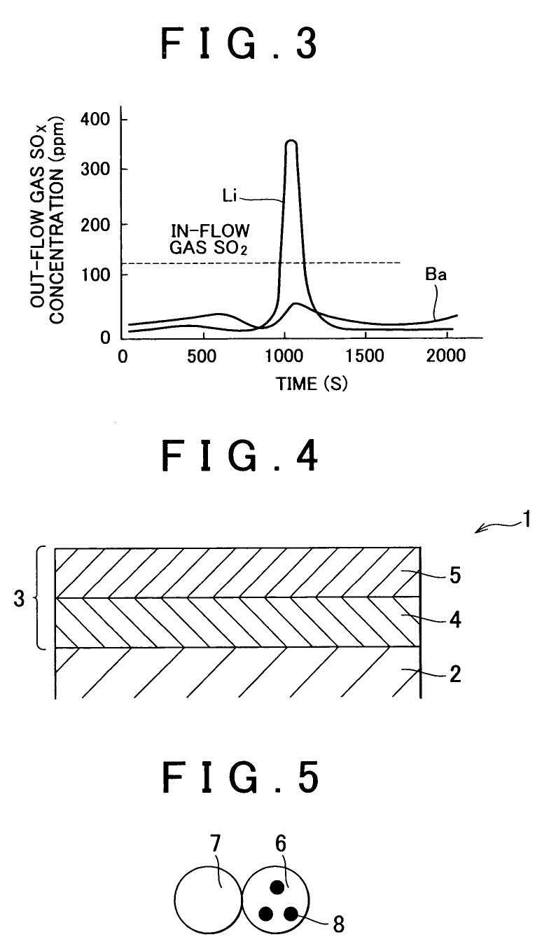

### DETAILED DESCRIPTION OF PREFERRED EMBODIMENTS

An exhaust gas cleaning catalyst according to the invention is formed of a catalyst carrier layer, a noble metal catalyst and a SOₓ absorbing agent both carried on the carrier layer. The catalyst carrier layer is formed of a porous oxide generally used as the carrier layer (or wash coat) of the catalyst. The porous oxide may be formed of alumina, silica, zirconia, silica-alumina, zeolite, and the like.

As the noble metal catalyst, at least one of platinum (Pt), rhodium (Rh), palladium (Pd), iridium (Ir), and ruthenium (Ru), or arbitral combination thereamong may be used as the general three-way catalyst. It is preferable to set a carry amount of the noble metal catalyst ranging from 0.1 to 10 wt % with respect to the amount of the carrier layer as the normal amount. If the amount is smaller than 0.1 wt. %, sufficient catalytic activity may not be obtained. If the amount exceeds 10 wt. %, the reaction is not activated sufficiently, resulting in added cost.

As the SOₓ absorbing agent, the substance that can be formed into the sulfate, which is formed of at least one of alkaline metal, alkaline earth metal, rare earth element, and transition metal may be employed. The aforementioned SOₓ absorbing agent may be carried on the carrier layer by itself or as an oxide. It may be formed into a composite oxide with the oxide that constitutes the carrier layer so as to be carried thereon. It is preferable to set the amount of the SOₓ absorbing agent to be carried to 20 wt % with respect to the carrier layer as the normal amount.

The carrier layer of the above structured exhaust gas cleaning catalyst have two distribution portions, one portion exhibiting a relatively lower sulfate retention and the other portion exhibiting a relatively higher sulfate retention. The noble metal catalyst is carried on the relatively lower sulfate retention distribution portion of the carrier layer.

The background of providing two distribution portions exhibiting different sulfate retentions in the carrier layer will be described. Firstly the SOₓ absorbing mechanism by the SOₓ absorbing agent will be explained. The mechanism has not been completely clarified yet, however, it may be explained in reference to the view shown in FIG. 1. In this case, the platinum (Pt) and barium (Ba) are carried on the catalyst carrier layer. However, arbitral material, for example, other noble metal catalyst, alkaline metal, alkaline earth metal and the like may be used to realize the similar mechanism as mentioned below.

In the case where the exhaust gas that flows into the catalyst is in substantially the lean state, the oxygen concentration of the in-flow exhaust gas is increased such that the oxygen adheres onto platinum (Pt) in the form of O₂⁻ as shown in FIG. 1. Meanwhile, SO contained in the in-flow exhaust gas reacts with the O₂⁻ on the platinum surface (Pt) into SO₃. A part of the generated SO₃ is further oxidized on the platinum (Pt) and absorbed by the SOₓ absorbing agent within the catalyst carrier layer, which is bonded with oxidized barium BaO. Accordingly, the resultant sulfate ion SO₄²⁻ diffuses to form a stable sulfate BaSO₄.

It is assumed that the SOₓ is absorbed by the SOₓ absorbing agent so as to be trapped as the sulfate in the aforementioned mechanism. The SOₓ trap ratio becomes different depending on the SOₓ absorbing agent. In the case where Ba and Li are used for the SOₓ absorbing agents, the catalyst that carries Li as the SOₓ absorbing agent has the SOₓ trap ratio that is higher than the catalyst that carries Ba as the SOₓ absorbing agent. Meanwhile, when both catalysts are heated to 600° C., the catalyst that carries Li releases SOₓ at a passage of time about 1000 seconds, and the catalyst that carries Ba retains SOₓ even at a passage of time over 2000 seconds. The bonding strength with SOₓ of the catalyst that carries Ba is higher than that with SOₓ of the catalyst that carries Li. The resultant bonding strength with SOₓ of those two different catalysts becomes inverse proportional to the SOₓ trap ratio. The catalyst that includes Ba as the SOₓ absorbing agent has S strongly absorbed on the catalytic surface, and the Ba within the catalyst does not contribute the trapping of SOₓ due to the absorbed SOₓ. Meanwhile the catalyst that includes Li as the SOₓ absorbing agent has the bonding strength with the SOₓ that is not so high. Accordingly the SOₓ trapped on the catalytic surface tends to diffuse toward the inside of the catalyst. The Li within the catalyst layer may contribute to trapping of the SOₓ using the whole catalytic layer. The resultant SOₓ trap ratio, thus, may be increased.

The generally employed catalyst is designed to bond the sulfate strongly such that the trapped sulfate is absorbed on the surface of the carrier layer strongly, and it is unlikely to diffuse toward the inside of the carrier layer. Then the S concentration on the surface increases, and the SOₓ trap ratio is decreased. Especially at a lower temperature, the sulfate ion cannot be diffused, thus reducing the SOₓ trap ratio considerably.

In the exhaust gas cleaning catalyst according to the invention, the carrier layer includes a relatively lower sulfate retention distribution portion and a relatively higher sulfate retention distribution portion, and the noble metal catalyst is carried on the relatively lower sulfate retention distribution portion. Accordingly the sulfate is oxidized by the noble metal catalyst, and the resultant sulfate ion flows into the lower sulfate retention distribution portion, and then diffuses into the higher sulfate retention distribution portion with strong force for trapping the SOₓ⁻ where the sulfate is settled thereon. There is no sulfate existing on the noble metal catalyst of the carrier layer such that the newly generated sulfate ion is allowed to flow into the carrier layer immediately. As a result, the whole catalyst carrier layer may be used for trapping the SOₓ so as to increase SOₓ trap amount.

The aforementioned plurality of distribution portions each exhibiting higher and lower sulfate retentions on the carrier layer is formed as a multiple layered structure. More specifically, examples of combinations of the low sulfate retention layer/the high sulfate retention layer will be described: (Li+alumina)/(Li+BaCO₃), (Li+LaZrOₓ)/(Li+LaZrOₓ+BaCO₃), (Li+CaZrOₓ)/(Li+CaZrOₓ+BaCO₃), (Li+K+alumina)/(Li+K+BaCO₃), (Na+alumina)/(Na+BaCO₃), (Li+K+LaZrOₓ)/(Li+K+LaZrOₓ+BaCO₃), (Li+BaCO₃+alumina)/(Li+BaCO₃), and the like. The carrier layer may be formed of a combination of particles with low sulfate retention and high sulfate retention. Alternatively the SOₓ absorbing agent to be carried on the carrier layer may be formed of materials exhibiting the low and high sulfate retentions which are separately arranged so as to form the layers of low and high sulfate retentions, respectively. The amount of the SOₓ absorbing agent that exhibits the sulfate retention may be relatively changed in the carrier layer so as to form the layers of low and high sulfate retentions.

The sulfate retention may be represented as likelihood of sulfate formation through the reaction between the SOₓ absorbing agent and SOₓ, or as unlikelihood of sulfate decomposition. The basicity of the SOₓ absorbing agent may be used for indicating the likelihood of the sulfate formation. The basicity is considered to indicate the level of ionizing potential. If the basicity is high, the force for positive ionizing is high, that is, exhibiting the strong force for trapping SOₓ⁻ as minus ions. That is, as the basicity measures a high value, the amount of trapping SOₓ becomes large.

The unlikelihood of the sulfate decomposition represents that the sulfate becomes unlikely to be decomposed as the decomposition temperature is increased, that is, high sulfate retention. The decomposition temperature of the sulfate for various elements will be listed in table below.

TABLE 1

| | DECOMPOSITION |
|---|---|
| | TEMPERATURE |
| ELEMENT | (° C.) |
| Ti | 150 |
| In | 250 |
| Sn | 360 |
| Bi | 405 |
| V | 410 |
| Fe | 480 |
| Gd | 500 |
| Be | 550 |
| Zn | 600 |
| Cu | 650 |
| Ga | 690 |
| Co | 735 |
| Al | 770 |
| Ni | 848 |
| Mn | 850 |
| Na | 884 |
| Yb | 900 |
| Y | 1000 |
| Cd | 1000 |
| Ag | 1085 |
| La | 1150 |
| Mg | 1185 |
| Ca | 1450 |
| Ba | 1580 |
| Sr | 1605 |
| K | 1689 |
| Rb | 1700 |

FIG. 4 is a view specifically showing the exhaust gas cleaning catalyst according to the invention. An exhaust gas cleaning catalyst 1 includes a carrier base 2 and a carrier layer 3 formed thereon. The surface of the carrier layer 3, that is, the surface at the side of the exhaust gas passage opposite to the carrier base 2 carries the noble metal catalyst. The carrier layer 3 has the SOₓ absorbing agent carried therein.

A monolith carrier base formed of the heat resistance ceramics, for example, cordierite, a metal carrier base formed of the metal film and the like may be employed as the carrier base 2. The noble metal catalyst and the SOₓ absorbing agent may be formed of the materials as described above.

The carrier layer 3 is formed of a porous oxide having a lower layer 4 and an upper layer 5. The lower layer 4 at the carrier base side exhibits a relatively higher sulfate retention than that of the upper layer 5 at the exhaust gas passage side. The sulfate ion generated on the surface of the upper layer 5 diffuses toward the lower layer 4 exhibiting the higher sulfate retention and trapped therein as the sulfate. Materials used for combinations of the upper layer 5/lower layer 4 may include: (Li+alumina)/(Li+BaCO₃), (Li+LaZrOₓ)/(Li+LaZrOₓ+BaCO₃), (Li+CaZrOₓ)/(Li+CaZrOₓ+BaCO₃), (Li+K+alumina)/(Li+K+BaCO₃), (Na+alumina)/(Na+BaCO₃), (Li+K+LaZrOₓ)/(Li+K+LaZrOx+BaCO₃), (Li+BaCO₃+alumina)/(Li+BaCO₃) and the like. The amount of the SOₓ absorbing agent in the lower layer 4 (generally indicating the sulfate retention) may be larger than that of the SOₓ absorbing agent in the upper layer 5. The sulfate retention of the SOₓ absorbing agent in the lower layer 4 may be made higher than that of the SOₓ absorbing agent in the upper layer 5. In this embodiment, the carrier layer has a double layer structure. However, it may include three or more layers so long as the sulfate retention of the lower layer is relatively higher than that of the upper layer.

The sulfate retention of the lower layer 4 of the carrier layer 3 is made higher than that of the upper layer 5 such that the sulfate ion generated through oxidization on the upper layer surface in contact with the exhaust gas is promoted to diffuse toward the lower layer that exhibits higher sulfate retention. This makes it possible to trap the SOₓ deep in the carrier layer without accumulating the sulfate in the upper layer, more specifically, around the surface in contact with the exhaust gas, thus increasing the SOₓ absorbing amount.

The exhaust gas cleaning catalyst may be produced through a generally employed process. For example, the lower layer is formed on the carrier base using a wet coat process and the like, and the upper layer is formed, on which the noble metal catalyst and the SOₓ absorbing agent are carried. The powder having the noble metal catalyst preliminarily carried on the porous oxide powder may be used to form the carrier layer on which the SOₓ absorbing agent is carried. Alternatively the porous oxide powder having the noble metal catalyst carried thereon is mixed with the porous oxide powder having the SOₓ absorbing agent carried thereon so as to form the carrier layer.

Water solution of noble metal compound containing noble metal salt is used to carry the noble metal catalyst on the porous oxide or the carrier layer through a generally employed absorption carrier process, water absorption carrier process or the like. Water solution of acetate salt of the SOₓ absorbing agent such as alkaline metal is used to carry the SOₓ absorbing agent through the water absorption carrier process or the like. Alternatively a composite oxide containing the oxide as the carrier layer and the SOₓ absorbing agent may be formed through the sol/gel process or the coprecipitation process.

FIG. 5 is a view showing another embodiment of the exhaust gas cleaning catalyst according to the invention. The carrier layer of the exhaust gas cleaning catalyst is formed of particles 6 with relatively lower sulfate retention (for example, Al₂O₃ that carries LiK), and particles 7 with relatively higher sulfate retention (for example, Al₂O₃ that carries LiK). A noble metal catalyst 8 is carried on the surface of the particle 6 with relatively lower sulfate retention. The SOₓ absorbing agent (not shown) is carried on each surface of the particles 6 and 7. In this embodiment, the carrier layer is formed of a combination of particles with different sulfate retentions. Accordingly the sulfate ion formed through oxidization by the noble metal catalyst diffuses toward the particles with relatively higher sulfate retention, and is settled therein. Then the sulfate is not accumulated around the noble metal catalyst so as to increase the SOₓ absorbing amount without interfering the SOₓ absorbing function.

The exhaust gas cleaning catalyst in this embodiment is prepared by mixing the porous oxide powder with relatively lower sulfate retention having the noble metal catalyst carried thereon with the porous oxide powder with relatively higher sulfate retention having the SOₓ absorbing agent carried thereon, and using the mixture for forming the carrier layer on the carrier base.

The exhaust gas cleaning catalyst according to the invention is provided within an exhaust passage of an internal combustion engine so as to effectively remove sulfur components contained in the exhaust gas. The exhaust gas cleaning catalyst may be combined with the NOₓ absorbing/reducing catalyst so that the exhaust gas cleaning catalyst is arranged upstream side of the exhaust passage and the NOₓ absorbing/reducing catalyst is arranged downstream side of the exhaust passage. A reducing agent supply valve for supplying the reducing agent such as hydrocarbon is provided between the aforementioned catalysts such that the exhaust gas cleaning catalyst traps the SOₓ in the exhaust gas discharged from the internal combustion engine operated in the lean-burn state where the average A/F ratio is lean, and the NOₓ absorbing/reducing catalyst traps the NOₓ, respectively. Then the reducing agent is supplied from the reducing agent supply valve into the NOₓ absorbing/reducing catalyst such that the exhaust gas flowing thereinto is brought into the rich state. Accordingly the NOₓ is discharged and reduced.

1. An exhaust gas cleaning catalyst that includes a carrier layer, and a noble metal catalyst and a SOₓ absorbing agent both carried on the carrier layer, wherein the carrier layer includes at least a first distribution portion and a second distribution portion each having a different sulfate retention level, the sulfate retention level of the first distribution portion is lower than the sulfate retention level of the second distribution portion, and the noble metal catalyst is carried on the first distribution portion such that a SOₓ that has been oxidized on the noble metal catalyst diffuses toward the second distribution portion so as to be settled therein.

2. An exhaust gas cleaning catalyst that includes a carrier layer, and a noble metal catalyst and a SOₓ absorbing agent both carried on the carrier layer, wherein the carrier layer includes at least a first distribution portion and a second distribution portion each having a different basic level, the basic level of the first distribution portion is lower than the basic level of the second distribution portion, and the noble metal catalyst is carried on the first distribution portion such that a SOₓ that has been oxidized on the noble metal catalyst diffuses toward the second distribution portion so as to be settled therein.

3. An exhaust gas cleaning catalyst that includes a carrier layer, and a noble metal catalyst and a SOₓ absorbing agent both carried on the carrier layer, wherein the carrier layer includes at least a first distribution portion and a second distribution portion each having a different sulfate decomposition temperature, the sulfate decomposition temperature of the first distribution portion is lower than the sulfate decomposition temperature of the second distribution portion, and the noble metal catalyst is carried on the first distribution portion such that a SOₓ that has been oxidized on the noble metal catalyst diffuses toward the second distribution portion so as to be settled therein.

4. The exhaust gas cleaning catalyst according to claim 1, wherein the carrier layer is coated on a surface of a carrier base material, the noble metal catalyst is carried on a surface of the carrier layer at a side of an exhaust gas passage, the first distribution portion of the carrier layer is disposed to the side of the exhaust gas passage, and the second distribution portion of the carrier layer is disposed to a side of the carrier base material such that the sulfate retention level of an outer side of the carrier layer is lower than that of an inner side below the outer side of the carrier layer so as to diffuse the SOₓ oxidized on the outer side of the carrier layer toward the inner side of the carrier layer to be settled therein.

5. The exhaust gas cleaning catalyst according to claim 1, wherein the carrier layer is formed of at least a first particle and a second particle each having a different sulfate retention level, the sulfate retention level of the first particle is lower than the sulfate retention level of the second particle, the noble metal catalyst is carried on the first particle, and the SOₓ that has been oxidized on the noble metal catalyst is diffused toward the second particle so as to be settled therein.
